(19) United States
(12) Patent Application Publication
(10) Pub. No.: US 2011/0243583 A1
(43) Pub. Date: Oct. 6, 2011

(54) IMAGE FORMING APPARATUS AND METHOD OF ADJUSTING GAP BETWEEN PEELING MEMBER AND FIXING MEMBER

(75) Inventor: Norio Tanaka, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 13/079,628

(22) Filed: Apr. 4, 2011

Related U.S. Application Data
(60) Provisional application No. 61/321,022, filed on Apr. 5, 2010.

(51) Int. Cl. G03G 15/20

(52) U.S. Cl. 399/22; 399/323; 399/45

(57) ABSTRACT

According to one embodiment, an image forming apparatus includes a fixing member, a peeling member, a driving mechanism, and a driving-mechanism control unit. The fixing member comes into press contact with a sheet while rotating and heats the sheet. The peeling member peels the sheet off the fixing member. The driving mechanism moves the peeling member to change the size of a gap between the distal end of the peeling member and the fixing member. The driving-mechanism control unit controls the driving mechanism to set the size of the gap.

### CROSS-REFERENCE TO RELATED APPLICATION

This application is based upon and claims the benefit of priority from U.S. provisional application 61/321,022, filed on Apr. 5, 2010; the entire contents of which are incorporated herein by reference.

### FIELD

Embodiments described herein relates generally to a technique for adjusting a gap between a peeling member and a fixing member.

### BACKGROUND

In the past, there is known a peeling plate for peeling a sheet off a fixing member such as a fixing roller or a fixing belt. The peeling plate is fixed to a frame or a housing with a small gap kept between the distal end of the peeling plate and the fixing member. The gap between the peeling plate and the fixing member is adjusted when a product is assembled, when the product is unpacked, and when a serviceperson visits a customer and is not adjusted thereafter.

Therefore, if the gap between the peeling plate and the fixing member is set small when the gap is adjusted, it is easy to peel the sheet using the peeling plate. However, it is likely that the peeling plate comes into contact with the fixing member to deteriorate fixing performance of the fixing member and reduce the life of the fixing member.

On the other hand, if the gap between the peeling plate and the fixing member is set large when the gap is adjusted, the contact between the peeling plate and the fixing member can be prevented. However, it is difficult to peel the sheet using the peeling plate. If an image having a high printing ratio is formed on the sheet, a large amount of toner adheres to the sheet and the sheet easily sticks to the fixing member. When the large amount of toner adheres to the sheet and the sheet easily sticks to the fixing member in this way, if the gap between the peeling plate and the fixing member is set large, it is likely that the sheet cannot be peeled off by the peeling plate and the sheet twines around the fixing member.

### DESCRIPTION OF THE DRAWINGS

FIG. 1 is a block diagram of a system configuration of an image forming apparatus;

FIG. 2 is a sectional view of a printer;

FIG. 3 is a sectional view of a fixing device;

FIG. 4 is a diagram of the configurations of a peeling plate and a driving mechanism;

FIG. 5 is a front view of components configured to rotate the peeling plate;

FIG. 6 is a side view of the components;

FIG. 7 is a block diagram of functional units of the image forming apparatus;

FIG. 8 is a flowchart for explaining gap adjustment processing;

FIG. 9 is a table of gap setting values;

FIG. 10 is a diagram of an image forming apparatus according to a second embodiment including a thickness sensor;

FIG. 11 is a diagram of functional units of the image forming apparatus according to the second embodiment;

FIG. 12 is a flowchart for explaining gap adjustment processing according to the second embodiment;

FIG. 13 is a diagram of the operation of a peeling plate according to a third embodiment;

FIG. 14 is a diagram of functional units of an image forming apparatus according to the third embodiment;

FIG. 15 is a flowchart for explaining angle adjustment processing according to the third embodiment;

FIG. 16 is a diagram of another rotation example of the peeling plate;

FIG. 17 is a diagram of the operation of a peeling plate according to a fourth embodiment;

FIG. 18 is a diagram of functional units of an image forming apparatus according to the fourth embodiment; and

FIG. 19 is a flowchart for explaining distance adjustment processing according to the fourth embodiment.

### DETAILED DESCRIPTION

In general, according to one embodiment, an image forming apparatus includes a fixing member, a peeling member, a driving mechanism, and a driving-mechanism control unit. The fixing member comes into press contact with a sheet while rotating and heats the sheet. The peeling member peels the sheet off the fixing member. The driving mechanism moves the peeling member to change the size of a gap between the distal end of the peeling member and the fixing member. The driving-mechanism control unit controls the driving mechanism to set the size of the gap.

In general, according to another embodiment, an image forming apparatus includes a fixing member, a peeling member, a driving mechanism, and a driving-mechanism control unit. The fixing member comes into press contact with a sheet while rotating and heats the sheet. The peeling member peels the sheet off the fixing member. The driving mechanism rotates the peeling member to change the angle of the peeling member with respect to the fixing member. The driving-mechanism control unit sets the size of the angle.

In general, according to still another embodiment, an image forming apparatus includes a fixing member, a peeling member, a driving mechanism, and a driving-mechanism control unit. The fixing member comes into press contact with a sheet while rotating and heats the sheet. The peeling member peels the sheet off the fixing member. The driving mechanism translates the peeling member to change the position of the peeling member with respect to a fixing position for the sheet on the fixing member. The driving-mechanism control unit controls the driving mechanism to set the position of the peeling member with respect to the fixing position.

In general, according to still another embodiment, a gap adjusting method is a method of adjusting a gap between a fixing member and a peeling member in an image forming apparatus including the fixing member configured to come into press contact with a sheet while rotating and heat the sheet and the peeling member configured to peel the sheet off the fixing member. The method includes moving, with a driving mechanism, the peeling member to change the size of a gap between the distal end of the peeling member and the fixing member.

Embodiments are explained below with reference to the accompanying drawings.

### First Embodiment

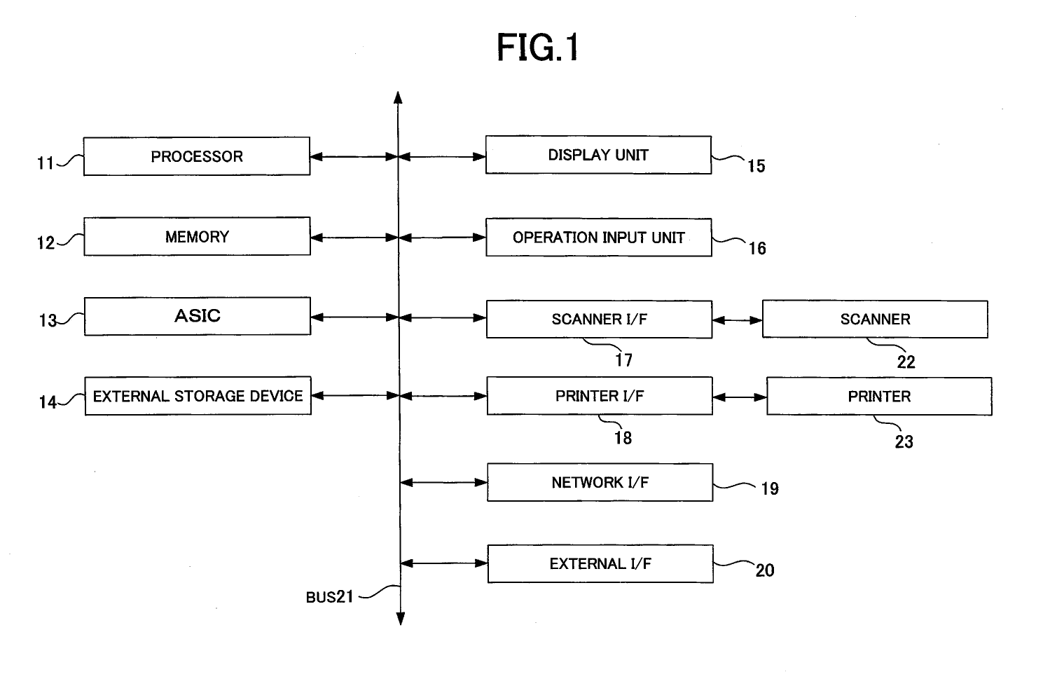

FIG. 1 is a block diagram of a system configuration of an image forming apparatus 10.

The image forming apparatus 10 is a MFP (Multi Function Peripheral). In the image forming apparatus 10, a processor 11, a memory 12, an ASIC (Application Specific Integrated Circuit) 13, an external storage device 14, a display unit 15, an operation input unit 16, a scanner I/F 17, a printer I/F 18, a network I/F 19, and an external I/F 20 are connected to one another via a bus 21. A scanner 22 is connected to the scanner I/F 17. A printer 23 is connected to the printer I/F 18.

The processor 11 reads out a computer program from the memory 12 and controls the entire image forming apparatus 10. The processor 11 may be a CPU (Central Processing Unit) or an MPU (Micro Processing Unit). The ASIC 13 may realize a part of functions realized by the processor 11. The memory 12 may be a RAM (Random Access Memory) or a ROM (Read Only Memory). The memory 12 stores the computer program read out by the processor 11. The external storage device 14 may be a HDD (Hard Disk Drive) or a flash memory. The external storage device 14 stores image data and the like. The display unit 15 may be an LCD (Liquid Crystal Display). The display unit 15 displays setting and the like related to the image forming apparatus 10. The operation input unit 16 may be buttons. The operation input unit 16 receives an operation input by a user. An external apparatus is connected to the network I/F 19 via a LAN line or the like. An external apparatus is connected to the external I/F 20 via an I/F such as a USB. The scanner 22 reads an image on a sheet. The printer 23 forms the image or the like read by the scanner 22 on a sheet.

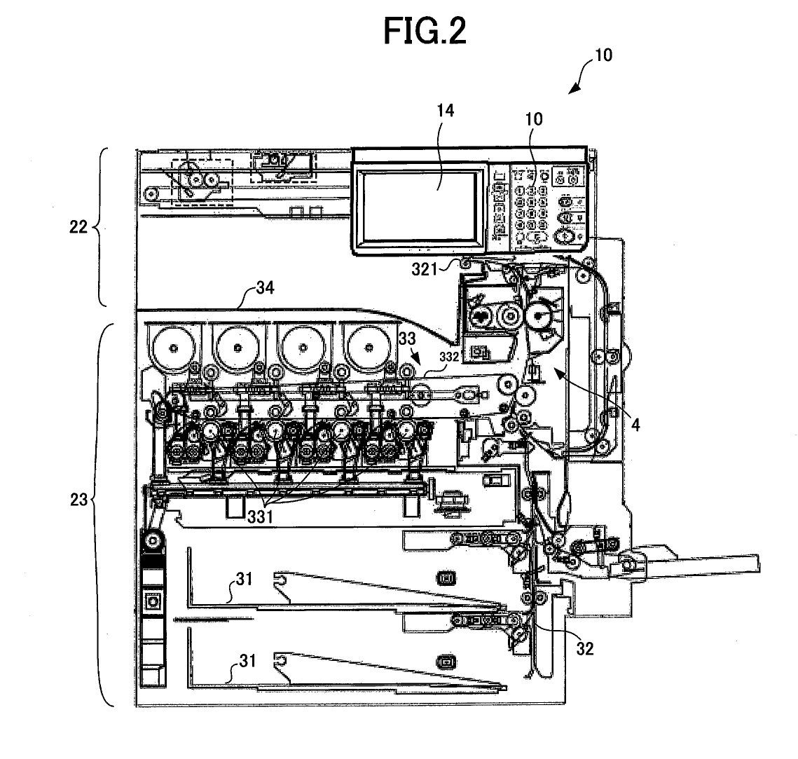

FIG. 2 is a sectional view of the printer 23.

The printer 23 includes a cassette 31, a sheet conveying unit 32, a transfer device 33, a fixing device 4, and a paper discharge tray 34. The cassette 31 stores sheets. The sheet conveying unit 32 acquires a sheet from the cassette 31, conveys the sheet to the units 32, 33, and 4, and then discharges, with a paper discharge roller 321, the sheet to the paper discharge tray 34.

The transfer device 33 includes a photoconductive member 331 on which an image is formed and a transfer belt 332 to which the image is transferred from the photoconductive member 331 and from which the image is transferred onto the sheet.

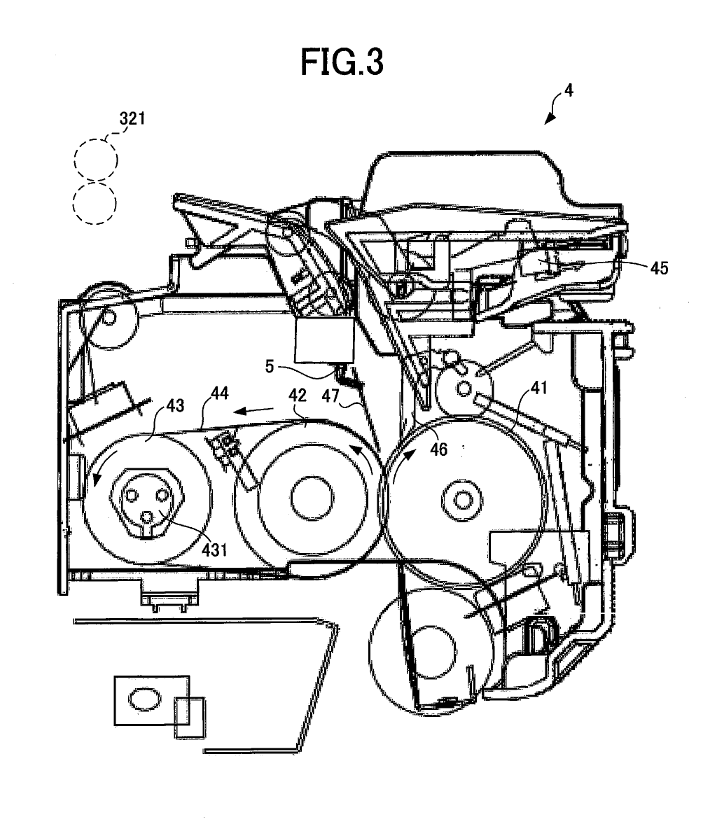

FIG. 3 is a sectional view of the fixing device 4.

The fixing device 4 includes a press roller 41, a fixing roller 42 (a first roller), a heat roller 43 (a second roller), a fixing belt 44 (a fixing member), a paper discharge sensor 45 (a jam sensor), a peeling pawl 46, a peeling plate 47 (a peeling member), and a driving mechanism 5.

The press roller 41 nips and conveys a sheet in cooperation with the fixing belt 44. The fixing roller 42 is opposed to the press roller 41 via the fixing belt 44. The heat roller 43 is heated by a heater 431 provided on the inside of the heat roller 43 and heats the fixing belt 44.

The fixing belt 44 comes into press contact with the sheet while rotating and heats the sheets and fixes a toner adhering to the sheet on the sheet. The fixing belt 44 is wound around the fixing roller 42 and the heat roller 43 and turned by the fixing roller 42 and the heat roller 43.

The paper discharge sensor 45 is an optical sensor and detects a sheet that passes the fixing belt 44 and the press roller 41. The paper discharge sensor 45 is a sensor for detecting whether the leading end of the sheet reaches the paper discharge roller 321 and detecting occurrence of a paper clogging in the fixing device 4, i.e., occurrence of a jam in the fixing device 4. The distal end of the peeling pawl 46 is in contact with or spaced a small distance apart from the press roller 41 and peels a sheet sticking to the press roller 41 off the press roller 41.

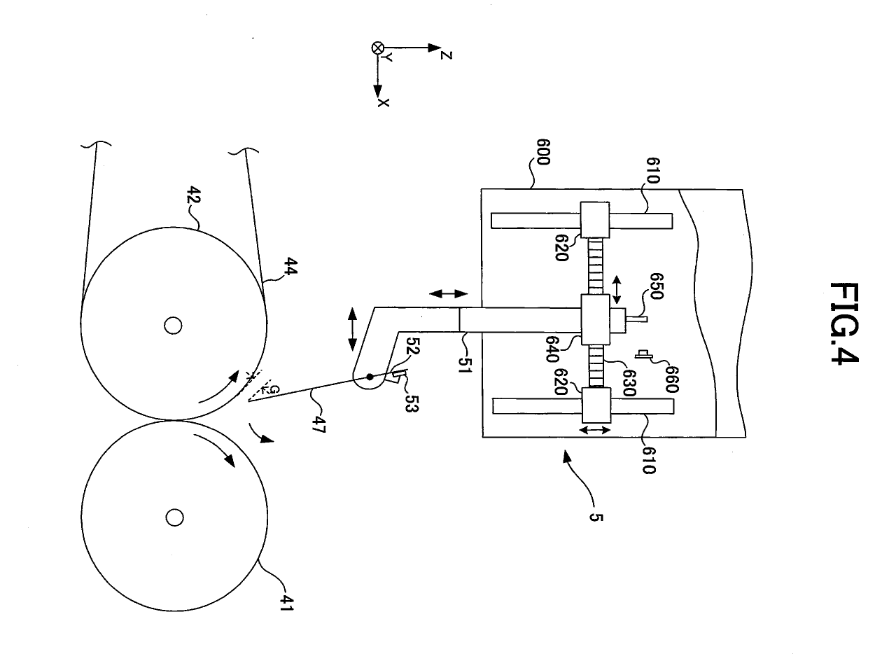

FIG. 4 is a diagram of the configurations of the peeling plate 47 and the driving mechanism 5. In FIG. 4, a Y direction is an axis direction of the fixing roller 42, a Z direction is an up down direction orthogonal to the Y direction, and an X direction is a direction orthogonal to the Y and Z directions.

The peeling plate 47 is tabular and arranged with a small gap G provided between the distal end of the peeling plate 47 and the fixing belt 44. The gap G means a smallest distance between the distal end of the peeling plate 47 and the fixing belt 44. The peeling plate 47 peels a sheet sticking to the fixing belt 44 off the fixing belt 44.

The driving mechanism 5 moves, before the start of printing by the image forming apparatus 10, the peeling plate 47 to change the size of the gap G between the distal end of the peeling plate 47 and the fixing belt 44 to a gap setting value set by the processor 11. Specifically, the driving mechanism 5 moves, before the start of the printing, the peeling plate 47 from a reference state in which the gap G is a reference value (in this embodiment, 0.5 mm) to gradually increase the gap G from the reference value to the gap setting value. The driving mechanism 5 moves, after the end of the printing, the peeling plate 47 to the reference state side to gradually reduce the gap G to the reference value. In this embodiment, the driving mechanism 5 causes the peeling plate 47 to rotate counterclockwise in FIG. 4 from the reference state shown in FIG. 4, in which the gap G is 0.5 mm, to increase the gap G to the gap setting value set by the processor 11. In this embodiment, the driving mechanism 5 can also change the size of the gap G by translating the peeling plate 47.

The driving mechanism 5 includes a supporting section 51, a marker 52, an HP sensor (Home Position Sensor) 53, and a translating mechanism 600.

The supporting section 51 holds the peeling plate 47 and rotates the peeling plate 47 to change the size of the gap G between the peeling plate 47 and the fixing belt 44.

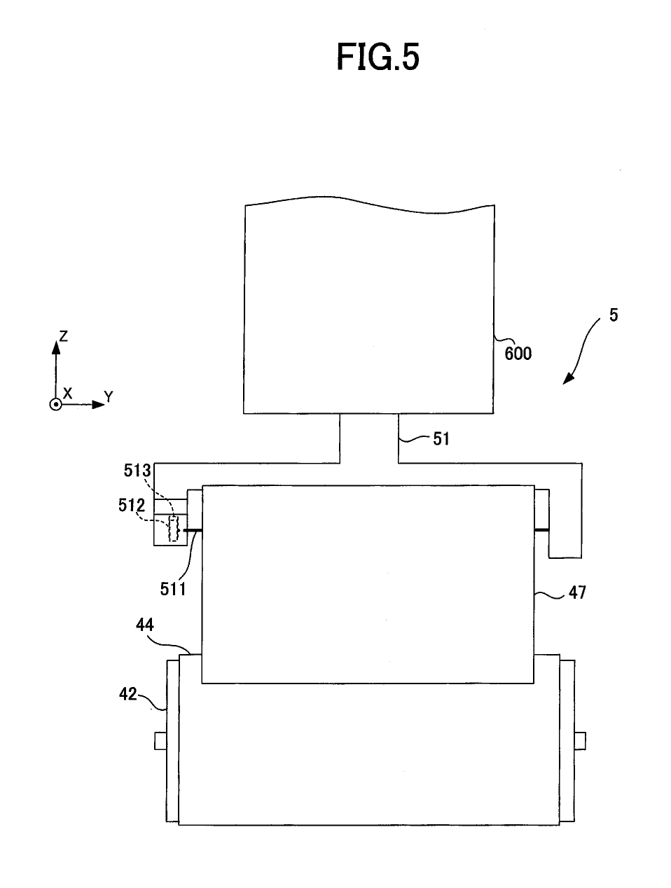

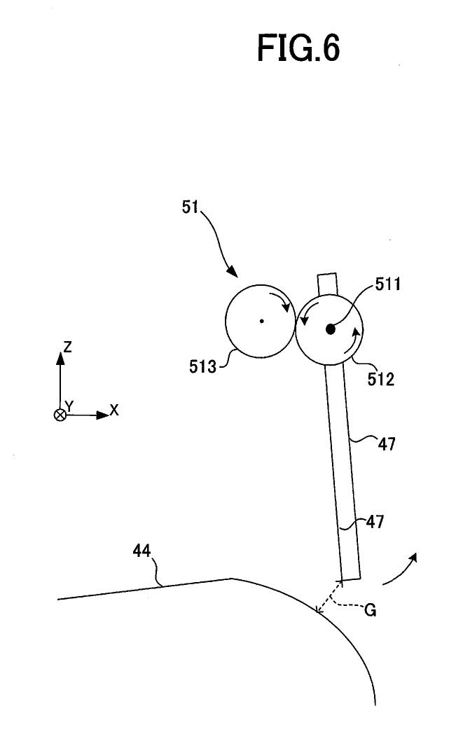

FIGS. 5 and 6 are diagrams of an example of components configured to rotate the peeling plate 47.

The supporting section 51 includes, for example, a rotating shaft 511 connected to the peeling plate 47 and rotatably supported, a gear 512 connected to the rotating shaft 511 and rotatably supported, and a gear 513 that meshes with the gear 512 and normally and reversely rotates according to rotation transmitted from a motor. The supporting section 51 rotates the rotating shaft 511, for example, counterclockwise in FIG. 6 via the gears 513 and 512 and rotates the peeling plate 47 counterclockwise in FIG. 6 to thereby increase the gap G to the gap setting value set by the processor 11. The supporting section 51 may rotate the peeling plate 47 using a cam or a solenoid.

Referring back to FIG. 4, in this embodiment, the marker 52 is provided on the proximal end side of the peeling plate 47. The marker 52 may be provided separately from the peeling plate 47 and connected to the peeling plate 47.

The HP sensor 53 detects whether the peeling plate 47 is in the reference state (a home position). In this embodiment, the HP sensor 53 comes into contact with the marker 52 to detect that the peeling plate 47 is in the reference state and separates from the marker 52 to detect that the peeling plate 47 is not in the reference state.

The translating mechanism 600 translates the peeling plate 47 via the supporting section 51. For example, the translating mechanism 600 moves the supporting section 51 in the upward direction in FIG. 4 and move the peeling plate 47 in the upward direction to thereby increase the gap G. The translating mechanism 600 includes a pair of columns 610 extending in the up down direction and a pair of Z sliders 620 configured to move in the up down direction on the columns 610. The columns 610 are ball screws. The Z sliders 620 are ball screw nuts. The translating mechanism 600 includes an X beam 630 supported by the columns 610 and an X slider 640 configured to move on the X beam 630 and support the supporting section 51. A rack is provided on a side surface of the X beam 630. The X slider 640 rotates a pinion gear, which meshes with the rack, to thereby move on the X beam 630. The translating mechanism 600 drives the columns 610 (the ball screws) and the X slider 640 to thereby translate the peeling plate 47 via the supporting section 51.

The translating mechanism 600 includes a marker 650 and an HP sensor 660.

The marker 650 is, for example, a reflection plate and attached to the X slider 640. The HP sensor 660 is an optical sensor configured to emit light and receive light. The HP sensor 660 detects the marker 650 according to reflected light from the marker 650. The HP sensor 660 and the marker 650 are set in positions where the HP sensor 660 detects the marker 650 when the peeling plate 47 is in the reference state and the HP sensor 660 does not detect the marker 650 when the peeling plate 47 is not in the reference state. The HP sensor 660 detects whether the peeling plate 47 is in the reference state or not.

In this embodiment, besides the size of the gap G, the angle and the position of the peeling plate 47 with respect to the fixing belt 44 can be changed by the translating mechanism 600 and the supporting section 51.

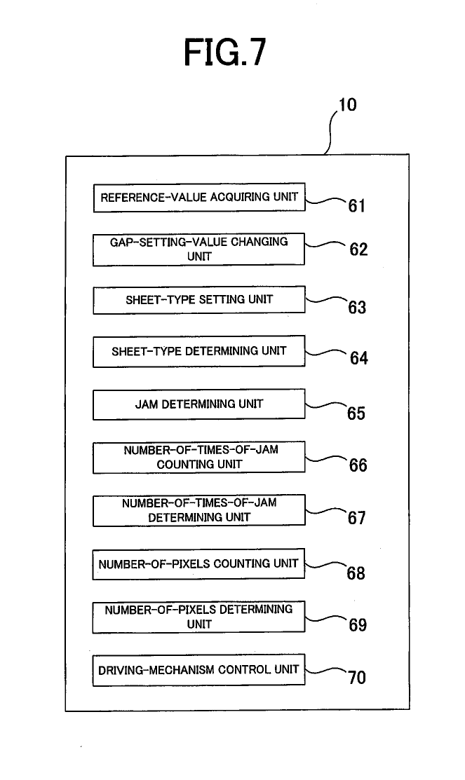

FIG. 7 is a block diagram of functional units of the image forming apparatus 10.

The image forming apparatus 10 includes, as functional units realized by the processor 11 reading the computer program stored in the memory 12, a reference-value acquiring unit 61, a gap-setting-value changing unit 62, a sheet-type setting unit 63, a sheet-type determining unit 64, a jam determining unit 65, a number-of-times-of-jam counting unit 66, a number-of-times-of-jam determining unit 67, a number-of-pixels counting unit 68, a number-of-pixels determining unit 69, and a driving-mechanism control unit 70.

The sheet-type setting unit 63 sets a type of a sheet according to an operation input to the operation input unit 16 by a user before the start of printing by the image forming apparatus 10. Types of sheets include thin paper, plain paper, and thick paper.

The jam determining unit 65 determines, based on a detection signal from the paper discharge sensor 45, whether a jam occurs in the fixing device 4.

The number-of-times-of-jam counting unit 66 counts, as the number of times of jam, the number of times the jam determining unit 65 determines that a jam occurs.

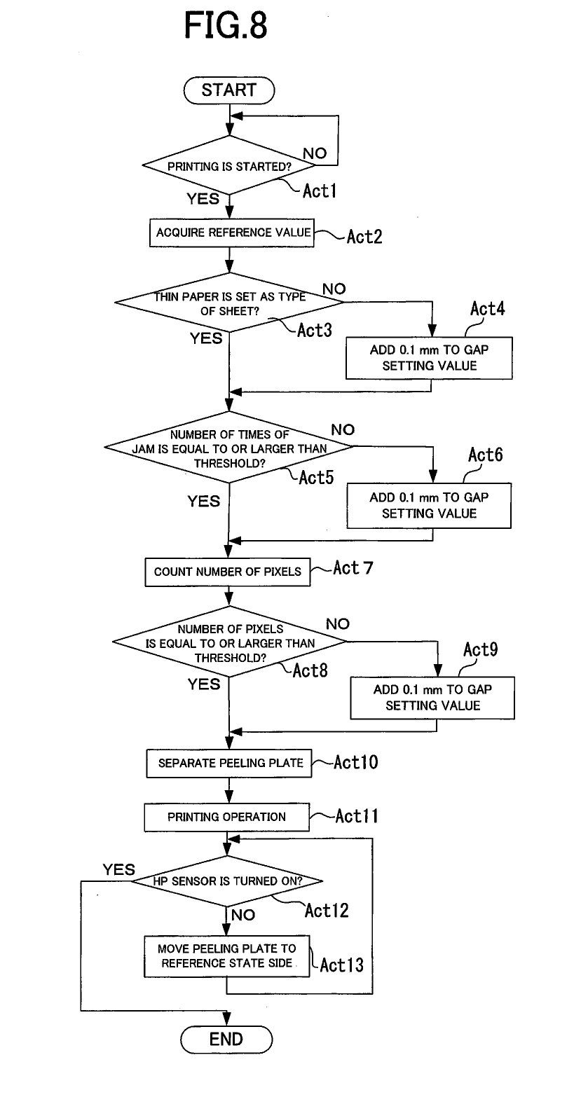

Processing for adjusting a gap between the fixing belt 44 and the peeling plate 47 by the image forming apparatus 10 is explained below with reference to a flowchart of FIG. 8. The gap adjustment processing is realized by the processor 11 reading the computer program stored in the memory 12.

The processor 11 receives a printing start instruction from the display device 15 according to, for example, an operation input to the operation input unit 16 (YES in Act 1).

After Act 1, the reference-value acquiring unit 61 acquires the reference value, which is a minimum, of the gap G from the memory 12. The reference-value acquiring unit 61 sets the gap setting value for changing the size of the gap G to the reference value (Act 2). In this embodiment, the reference value is set to 0.5 mm.

After Act 2, the sheet-type determining unit 64 determines whether a type of a sheet set by the user before the start of printing is thin paper (a first type) or paper other than the thin paper (a second type) such as plain paper or thick paper (Act 3).

If the sheet-type determining unit 64 determines that the type of the sheet is the paper other than the thin paper (NO in Act 3), the gap-setting-value changing unit 62 changes the gap setting value (Act 4). In this embodiment, the gap-setting-value changing unit 62 adds 0.1 mm to the gap setting value (the reference value 0.5 mm).

If the sheet-type determining unit 64 determines that the type of the sheet is the thin paper (YES in Act 3) and after Act 4, the number-of-times-of-jam determining unit 67 determines whether the number of times of jam occurred in the fixing device 4 is equal to or larger than a threshold (Act 5). The number-of-times-of-jam counting unit 66 counts the number of times of jam every time occurrence of a jam is detected by the paper discharge sensor 45.

If the number-of-times-of-jam determining unit 67 determines that the number of times of jam is smaller than the threshold (NO in Act 5), as in Act 4, the gap-setting-value changing unit 62 adds 0.1 mm to the gap setting value (Act 6).

If the number-of-times-of-jam determining unit 67 determines that the number of times of jam is equal to or larger than the threshold (YES in Act 5) and after Act 6, the number-of-pixels counting unit 68 counts, in image data that should be formed on the sheet, the number of pixels equivalent to a threshold line from the leading end of an image in a sheet conveying direction (Act 7). The number-of-pixels counting unit 68 counts the number of pixels on the leading end side of the image because an amount of toner adhering to the leading end side of the sheet in the sheet conveying direction affects occurrence of twining of the sheet around the fixing belt 44.

After Act 7, the number-of-pixels determining unit 69 determines whether the number of pixels counted by the number-of-pixels counting unit 68 is equal to or larger than a threshold (Act 8). If the number-of-pixels determining unit 69 determines that the number of pixels is smaller than the threshold (NO in Act 8), as in Act 4, the gap-setting-value changing unit 62 adds 0.1 mm to the gap setting value (Act 9). If the number-of-pixels determining unit 69 determines that the number of pixels is equal to or larger than the threshold (YES in Act 8), the gap-setting-value changing unit 62 does not change the gap setting value.

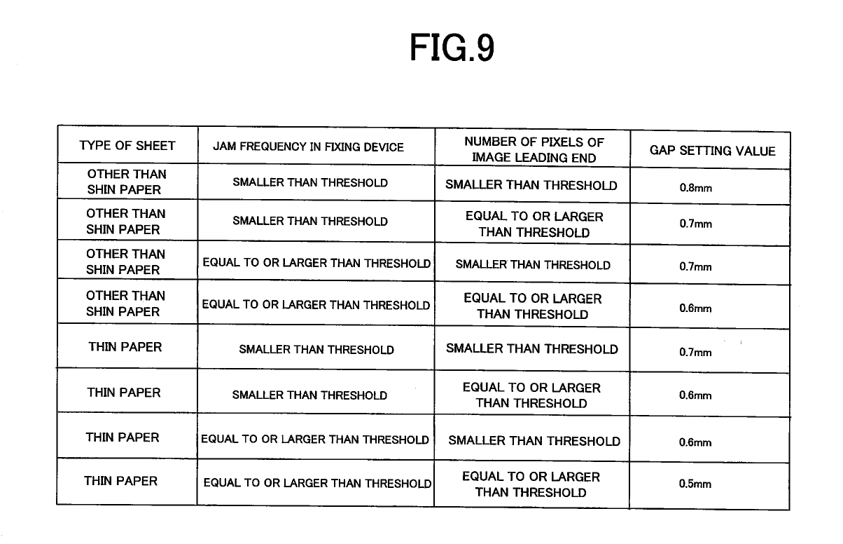

In the processing in Acts 2 to 9, the gap setting value is set as shown in FIG. 9. For example, if the type of the sheet is the paper other than the thin paper, the jam frequency is smaller than the threshold, and the number of pixels of the leading end of the image is smaller than the threshold, as shown at the top of FIG. 9, the gap setting value is 0.8 mm. If the type of the sheet is the thin paper, the jam frequency is equal to or larger than the threshold, and the number of pixels of the leading end of the image is equal to or larger than the threshold, as shown at the bottom of FIG. 9, the gap setting value remains at the reference value of 0.5 mm.

After Acts 2 to 9, the driving-mechanism control unit 70 rotates, with the driving mechanism 5, the peeling plate 47 to a side on which the gap G between the peeling plate 47 and the fixing belt 44 increases and sets the gap G to the gap setting value (Act 10). If the gap setting value remains at the reference value of 0.5 mm, the driving-mechanism control unit 70 does not move the peeling plate 47.

After Act 10, the image forming apparatus 10 forms an image on the sheet (Act 11).

If the driving-mechanism control unit 70 does not move the peeling plate 47 and the peeling plate 47 remains in the reference state in which the gap G is the reference value of 0.5 mm, after Act 11, the HP sensor 53 detects that the peeling plate 47 is in the reference state (YES in Act 12) and the gap adjustment processing ends.

If the gap G is larger than the reference value of 0.5 mm because the driving-mechanism control unit 70 moves the peeling plate 47, after Act 11, the HP sensor 53 detects that the peeling plate 47 is not in the reference state in which the gap G is the reference value of 0.5 mm (NO in Act 12). In that case, until the HP sensor 53 detects that the peeling plate 47 is in the reference state, the driving-mechanism control unit 70 rotates the peeling plate 47 to the reference state side, i.e., a side on which the gap G decreases and sets the gap G to the reference value of 0.5 mm (Act 13). If the HP sensor 53 detects that the peeling plate 47 is in the reference state (YES in Act 12), the gap adjustment processing ends.

In this embodiment, in the case of printing conditions (a type of a sheet, a jam frequency, and the number of pixels of the leading end of an image) under which it is difficult to peel the sheet off the fixing belt 44, the gap G between the peeling plate 47 and the fixing belt 44 can be reduced and the sheet can be surely peeled off the fixing belt 44 by the peeling plate 47.

On the other hand, in the case of printing conditions under which it is not so difficult to peel the sheet off the fixing belt 44, in this embodiment, the gap G can be increased. Therefore, in this embodiment, it is possible to prevent a situation in which fixing performance is unnecessarily deteriorated and the life of the fixing belt 44 decreases because the peeling plate 47 and the fixing belt 44 come into contact with each other and the fixing belt 44 is scratched.

As explained above, in this embodiment, it is possible to appropriately adjust the gap G between the peeling plate 47 and the fixing belt 44 according to the printing conditions and minimize occurrence of a jam due to twining of the sheet around the fixing belt 44.

In the example explained in this embodiment, the reference value of the gap G is 0.5 mm. However, the reference value of the gap G maybe 0 mm. In this case, the home position of the peeling plate 47 is a position where the peeling plate 47 is in contact with the fixing belt 44. Therefore, if the peeling plate 47 is kept in the home position because of the printing conditions under which it is difficult to peel the sheet off the fixing belt 44, since the peeling plate 47 and the fixing belt 44 are in contact with each other, the peeling can be surely performed. For example, the gap-setting-value changing unit 62 may subtracts a constant from or adds the constant to the gap setting value to change the gap setting value. In Act 10, the driving-mechanism control unit 70 may set the gap G to the gap setting value by translating the peeling plate 47 with the driving mechanism 5.

### Second Embodiment

Components same as those in the first embodiment are denoted by the same reference numerals and signs and explanation of the components is omitted.

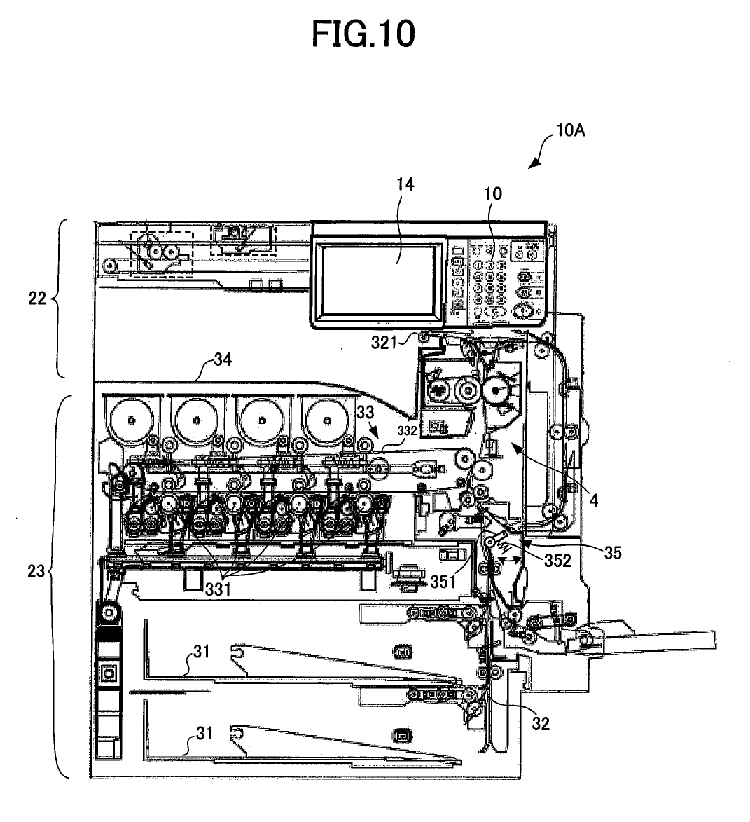

FIG. 10 is a diagram of an image forming apparatus 10A including a thickness sensor 35.

In the first embodiment, the thickness of a sheet is determined on the basis of a type of the sheet set by the user. However, the thickness of the sheet may be detected by the thickness sensor 35. The thickness sensor 35 detects the thickness of a sheet conveyed by the sheet conveying unit 32 and outputs a detection signal to a processor. The thickness sensor 35 includes, for example, a lever 351, an elastic member 352, and an optical sensor. The lever 351 rotates, for example, counterclockwise in FIG. 10 around a fulcrum according to the thickness of a sheet passing the thickness sensor 35. The elastic member 352 urges the lever 351 clockwise in FIG. 10. The optical sensor detects a rotation angle of the lever 351 and outputs a detection signal to the processor.

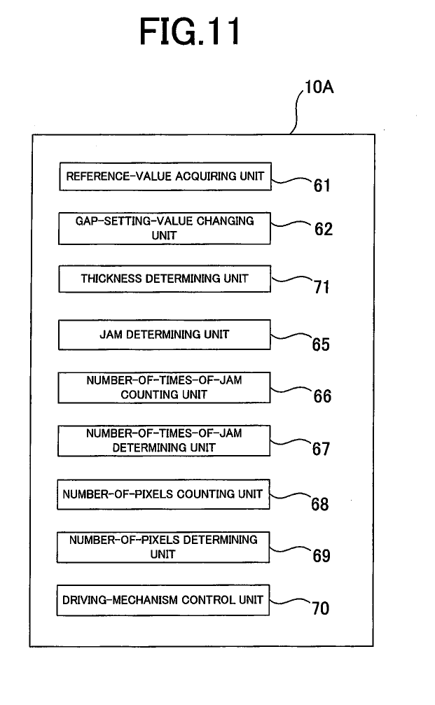

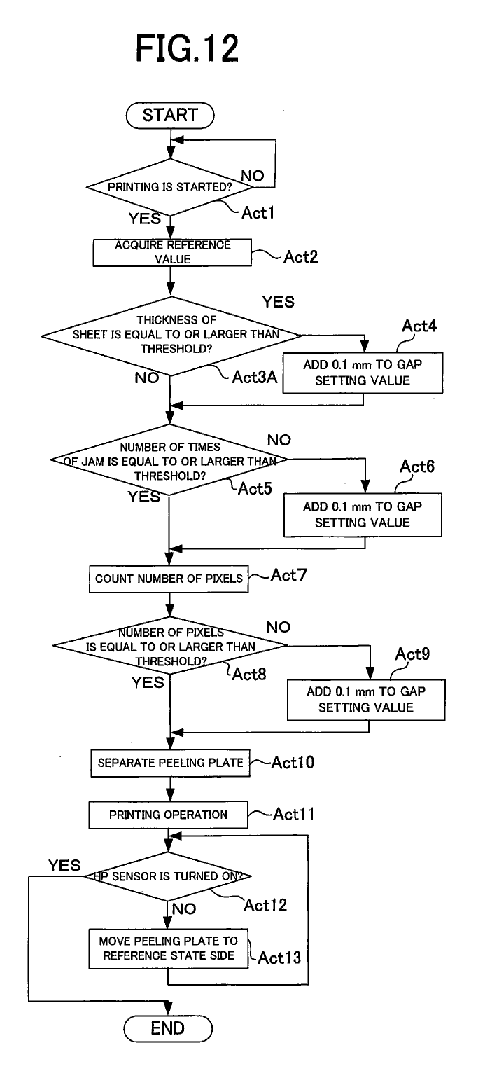

FIG. 11 is a diagram of functional units of the image forming apparatus 10A. FIG. 12 is a flowchart for explaining gap adjustment processing by the image forming apparatus 10A.

In this embodiment, as functional units of the image forming apparatus 10A, the image forming apparatus 10A includes a thickness determining unit 71 instead of the sheet-type setting unit 63 and the sheet-type determining unit 64 in the first embodiment. In the gap adjustment processing by the image forming apparatus 10A, only Act 3A is different from Act 3 in the first embodiment. In this embodiment, in Act 3A, the thickness determining unit 71 determines, on the basis of a detection signal from the thickness sensor 35, whether the thickness of a sheet, on which an image is to be formed, is equal to or larger than a threshold. If the thickness determining unit 71 determines that the thickness of the sheet is equal to or larger than the threshold (YES in Act 3A), for example, the gap-setting-value changing unit 62 adds 0.1 mm to the gap setting value to change the gap setting value (Act 4).

Other components in the second embodiment are the same as those in the first embodiment.

### Third Embodiment

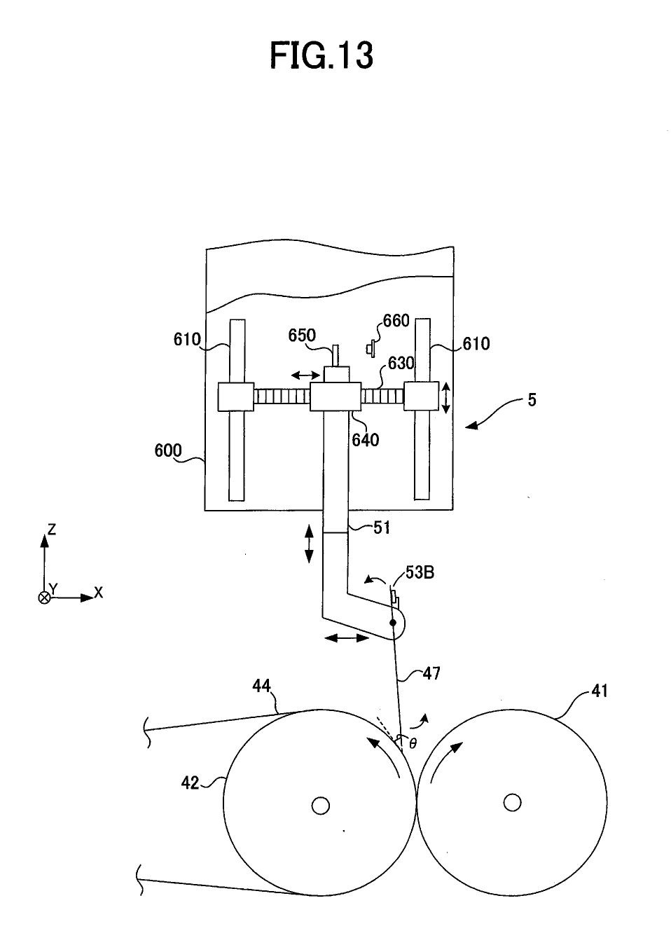

In the first and second embodiments, occurrence of a jam is minimized by changing the size of the gap G at several stages on the basis of printing conditions (a type of a sheet, a jam frequency, and the number of pixels of the leading end of an image). However, in a third embodiment, in the case of the printing conditions under which it is difficult to peel the sheet off the fixing belt 44, as shown in FIG. 13, the peeling plate 47 is rotated by the driving mechanism 5 to increase an angle θ of the peeling plate 47 with respect to the fixing belt 44. In the case of the printing conditions under which it is not so difficult to peel the sheet off the fixing belt 44, occurrence of a jam is minimized by rotating the peeling plate 47 to reduce the angle θ. In this case, the angle θ means an angle between an imaginary extended line of the peeling plate 47 to the fixing belt 44 side and a tangent of the fixing belt 44 at an intersection of the imaginary extended line and the fixing belt 44. In this embodiment, an HP sensor 53B detects whether the peeling plate 47 is in a reference state in which the angle θ with respect to the fixing belt 44 is a maximum.

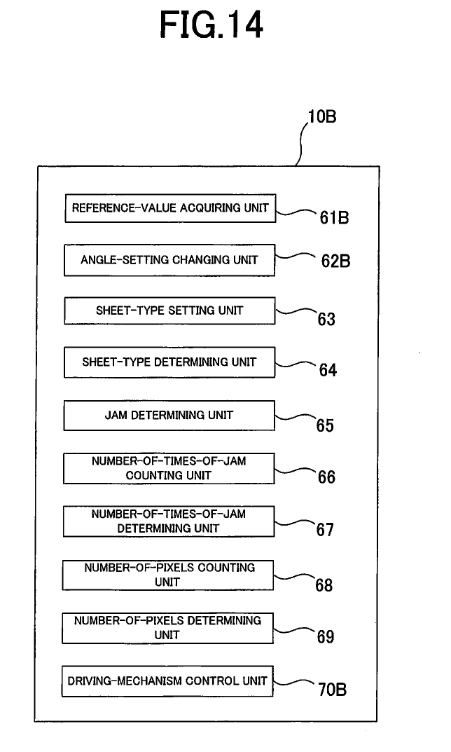

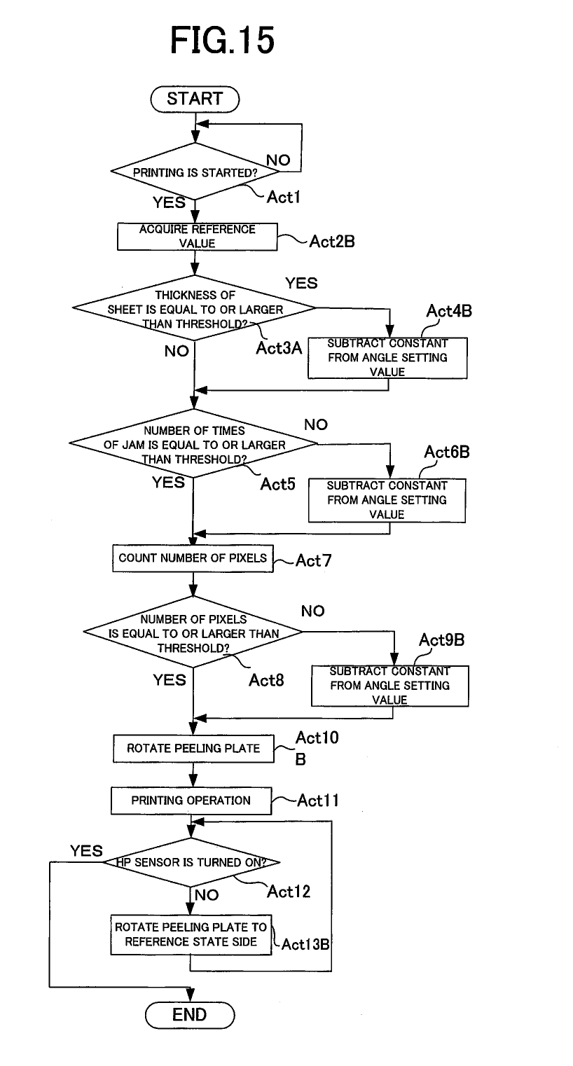

FIG. 14 is a diagram of functional units of an image forming apparatus 10B. FIG. 15 is a flowchart for explaining processing for adjusting the angle of the peeling plate 47 with respect to the fixing belt 44 by the image forming apparatus 10B.

In this embodiment, the image forming apparatus 10B includes, as functional units, a reference-value acquiring unit 61B, an angle-setting changing unit 62B, and a driving-mechanism control unit 70B instead of the reference-value acquiring unit 61, a gap-setting-value changing unit 62, and the driving-mechanism control unit 70 in the first embodiment.

A flow of the angle adjustment processing by the image forming apparatus 10B is briefly explained below.

If a processor receives a printing start instruction (Act 1), the reference-value acquiring unit 61B acquires a reference value, which is a maximum, of the angle θ from the memory 12. The reference-value acquiring unit 61B sets, to the reference value, an angle setting value for changing the size of the angle θ of the peeling plate 47 with respect to the fixing belt 44 (Act 2B).

Subsequently, if the sheet-type determining unit 64 determines that the type of the sheet is the paper other than the thin paper (YES in Act 3A), if the number-of-times-of-jam determining unit 67 determines that the number of times of jam is smaller than the threshold (NO in Act 5), and if the number-of-pixels determining unit 69 determines that the number of pixels is smaller than the threshold (NO in Act 8), for example, the angle-setting changing unit 62B subtracts a constant from the angle setting value to reduce the angle setting value (Acts 4B, 6B, and 9B). Subsequently, the driving-mechanism control unit 70B rotates the peeling plate 47 with the driving mechanism 5 and sets the angle θ of the peeling plate 47 with respect to the fixing belt 44 to the angle setting value (Act 10B).

After the image forming apparatus 10B forms an image on the sheet (Act 11), until the HP sensor 53B detects that the peeling plate 47 is in the reference state, the driving-mechanism control unit 70B rotates the peeling plate 47 to the reference state side (a side on which the angle θ of the peeling plate 47 with respect to the fixing belt 44 decreases) and sets the angle θ of the peeling plate 47 with respect to the fixing belt 44 to the reference value (Act 13B). If the HP sensor 53B detects that the peeling plate 47 is in the reference state (YES in Act 12B), the angle adjustment processing ends.

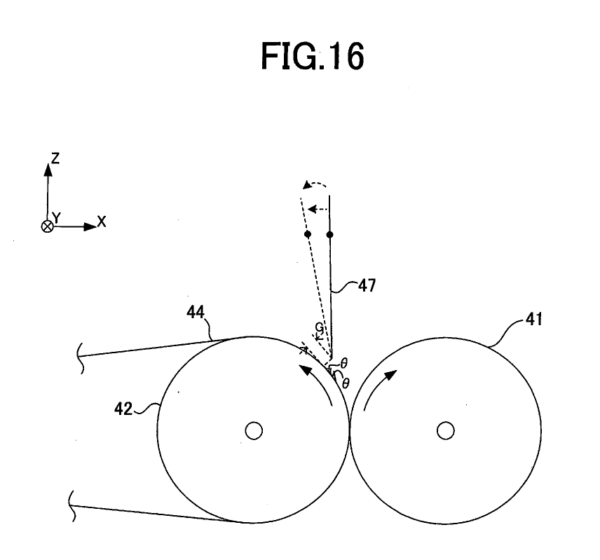

In this embodiment, the angle θ of the peeling plate 47 with respect to the fixing belt 44 is reduced from the reference value and the gap G between the peeling plate 47 and the fixing belt 44 is increased by rotating the peeling plate 47. However, as shown in FIG. 16, the angle θ may be reduced by rotating the peeling plate 47 while maintaining the gap G.

### Fourth Embodiment

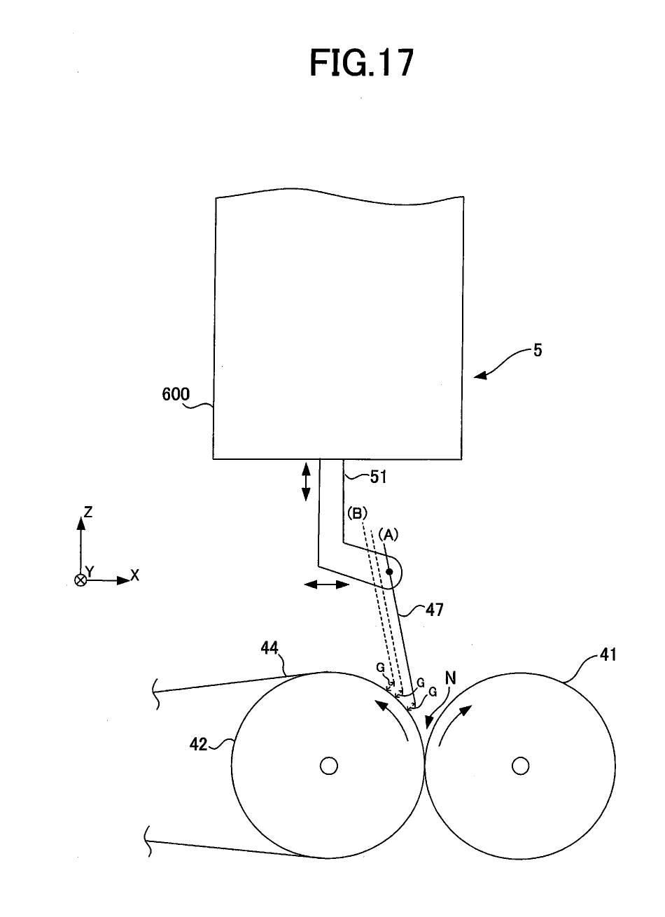

In a fourth embodiment, in the case of the printing conditions under which it is difficult to peel the sheet off the fixing belt 44, as shown in FIG. 17, the translating mechanism 600 of the driving mechanism 5 translates the peeling plate 47 to, for example, a position (A) near a fixing position N for a sheet by the fixing belt 44 (a nip N between the fixing belt 44 and the press roller 41) while keeping the gap G. In the case of the printing conditions under which it is not so difficult to peel the sheet off the fixing belt 44, the translating mechanism 600 translates the peeling plate 47 to, for example, a position (B) in FIG. 17 further apart from the fixing position N than the position (A). In this embodiment, the HP sensor detects whether the position of the peeling plate 47 is in the reference state in which a distance from the distal end of the peeling plate 47 to the fixing position N is a minimum when the gap G is a predetermined value.

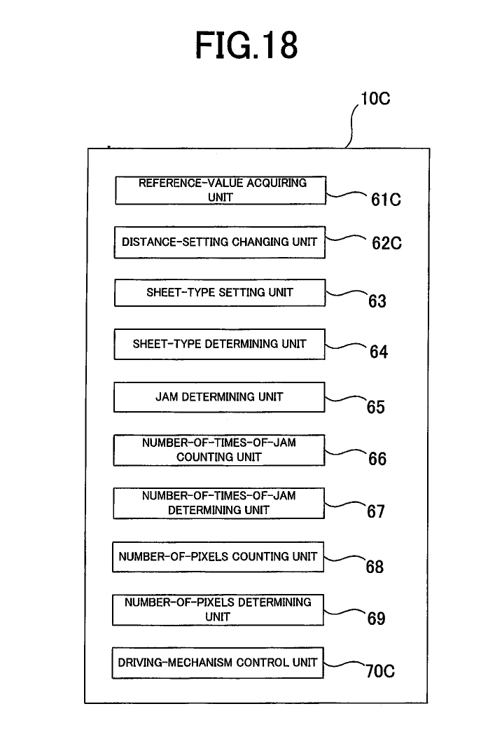

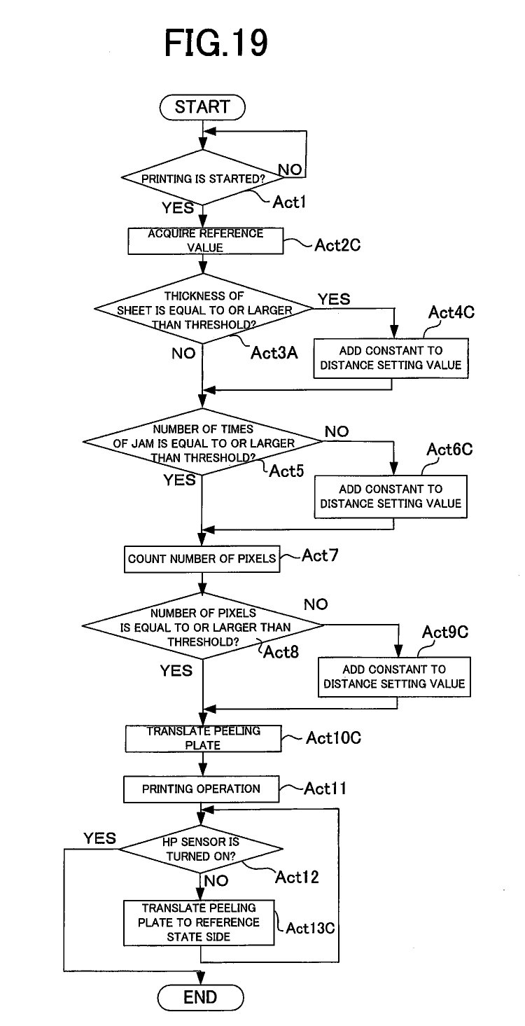

FIG. 18 is diagram of functional units of an image forming apparatus 10C. FIG. 19 is a flowchart for explaining processing for adjusting a distance from the peeling plate 47 to the nip N by the image forming apparatus 10C.

A flow of the angle adjustment processing by the image forming apparatus 10C is briefly explained below.

If a processor receives a printing start instruction (Act 1), a reference-value acquiring unit 61C acquires, from the memory, a reference value at which the distance from the distal end of the peeling plate 47 to the fixing position N is a maximum. The reference-value acquiring unit 61C sets, to the reference value, a distance setting value for changing the size of the distance to the fixing position N (Act 2C).

Subsequently, if the sheet-type determining unit 64 determines that a type of the sheet is the paper other than the thin paper (YES in Act 3A), if the number-of-times-of-jam determining unit 67 determines that the number of times of jam is smaller than the threshold (NO in Act 5), and if the number-of-pixels determining unit 69 determines that the number of pixels is smaller than the threshold (NO in Act 8), for example, a distance-setting changing unit 62C adds a constant to the distance setting value to increase the distance setting value (Acts 4C, 6C, and 9C). Subsequently, a driving-mechanism control unit 70C translates the peeling plate 47 with the translating mechanism 600 while keeping the gap G and sets the distance from the distal end of the peeling plate 47 to the fixing position N to the distance setting value (Act 10C).

After the image forming apparatus 10C forms an image on the sheet (Act 11), until the HP sensor 53B detects that the peeling plate 47 is in the reference state, the driving-mechanism control unit 70C translates the peeling plate 47 to the reference state side (a side on which the distance from the distal end of the peeling plate 47 to the fixing position N increases) and sets the distance from the distal end of the peeling plate 47 to the fixing position N to the reference value (Act 13C). If the HP sensor detects that the peeling plate 47 is in the reference state (YES in Act 12C), the distance adjustment processing ends.

A form of a recording medium may be any form as long as the recording medium can store a computer program and can be read by a computer. Specifically, examples of the recording medium include an internal storage device internally mounted in the computer such as a ROM or a RAM, a portable storage medium such as a CD-ROM, a flexible disk, a DVD disk, a magneto-optical disk, or an IC card, a database that stores a computer program, or other computers and databases of the computers. Functions obtained by installation or download may be realized in cooperation with an OS or the like in an apparatus. The computer program may be an execution module dynamically generated partially or entirely.

The order of the kinds of processing in the embodiments maybe different from the order illustrated in the embodiments.

As explained in detail above, according to the technique described in this specification, it is possible to provide a technique for adjusting a gap between a peeling member and a fixing member.

While certain embodiments have been described, these embodiments have been presented by way of example only, and are not intended to limit the scope of invention. Indeed, the novel apparatus, methods and system described herein may be embodied in a variety of other forms; furthermore, various omissions, substitutions and changes in the form of the apparatus, methods and system described herein may be made without departing from the spirit of the inventions. The accompanying claims and their equivalents are intended to cover such forms or modifications as would fall within the scope and spirit of the inventions.

What is claimed is:

1. An image forming apparatus comprising:
a fixing member configured to come into press contact with a sheet while rotating and heat the sheet;
a peeling member configured to peel the sheet off the fixing member;
a driving mechanism configured to move the peeling member to change size of a gap between a distal end of the peeling member and the fixing member; and
a driving-mechanism control unit configured to control the driving mechanism and set the size of the gap.

2. The apparatus according to claim 1, further comprising:
an operation input unit configured to receive an operation input by a user;
a sheet-type setting unit configured to set, according to the operation input to the operation input unit, a type of the sheet to one of a first type and a second type having larger sheet thickness than the first type; and
a sheet-type determining unit configured to determine whether the type of the sheet set by the sheet-type setting unit is the first type or the second type, wherein
the driving-mechanism control unit sets the gap larger if the sheet-type determining unit determines that the type of the sheet is the second type than if the sheet-type determining unit determines that the type of the sheet is the first type.

3. The apparatus according to claim 2, further comprising:
a sheet conveying unit configured to convey the sheet to the fixing member;
a thickness sensor configured to detect thickness of the sheet conveyed by the sheet conveying unit; and
a thickness determining unit configured to determine whether the thickness of the sheet detected by the thickness sensor is equal to or larger than a threshold, wherein
the driving-mechanism control unit sets the gap larger if the thickness determining unit determines that the thickness of the sheet is equal to or larger than the threshold than if the thickness determining unit determines that the thickness of the sheet is smaller than the threshold.

4. The apparatus according to claim 1, further comprising:
a jam sensor configured to detect the sheet that passes the fixing member;
a jam determining unit configured to determine, on the basis of a detection signal from the jam sensor, whether a sheet jam occurs;
a number-of-times-of-jam counting unit configured to count, as a number of times of jam, a number of times the jam determining unit determines that the sheet jam occurs; and
a number-of-times-of-jam determining unit configured to determine whether the number of times of jam is equal to or larger than a threshold, wherein
the driving-mechanism control unit sets the gap larger if the number-of-times-of-jam determining unit determines that the number of times of jam is equal to or larger than the threshold than if the number-of-times-of-jam determining unit determines that the number of times of jam is smaller than the threshold.

5. The apparatus according to claim 1, further comprising:
a number-of-pixels counting unit configured to count a number of pixels of an image that should be formed on the sheet; and
a number-of-pixels determining unit configured to determine whether the number of pixels is equal to or larger than a threshold, wherein
the driving-mechanism control unit sets the gap larger if the number-of-pixels determining unit determines that the number of pixels is equal to or larger than the threshold than if the number-of-pixels determining unit determines that the number of pixels is smaller than the threshold.

6. The apparatus according to claim 1, wherein
the driving mechanism moves the peeling member from a reference state in which the gap is a minimum to gradually increase the gap from the minimum and moves the peeling member after the movement from the reference state to the reference state side to gradually reduce the gap to the minimum,
the apparatus further comprises a home position sensor configured to detect whether the peeling member is in the reference state, and
the driving-mechanism control unit moves, before the image forming apparatus forms an image on the sheet, the peeling member from the reference state to increase the gap and moves, after the image forming apparatus forms the image on the sheet, the peeling member to the reference state side until the home position sensor detects that the peeling member is in the reference state.

7. The apparatus according to claim 1, wherein the driving mechanism rotates the peeling member to change the gap.

8. The apparatus according to claim 1, wherein the driving mechanism translates the peeling member to change the gap.

9. The apparatus according to claim 1, further comprising:
a first roller;
a second roller; and
a fixing belt as the fixing member wound around the first roller and the second roller.

10. The apparatus according to claim 1, wherein the fixing member is a fixing roller configured to directly come into press contact with the sheet.

11. An image forming apparatus comprising:
a fixing member configured to come into press contact with a sheet while rotating and heat the sheet;
a peeling member configured to peel the sheet off the fixing member;
a driving mechanism configured to rotate the peeling member to change an angle of the peeling member with respect to the fixing member; and
a driving-mechanism control unit configured to control the driving mechanism and set a size of the angle.

12. The apparatus according to claim 11, further comprising:
an operation input unit configured to receive an operation input by a user;
a sheet-type setting unit configured to set, according to the operation input to the operation input unit, a type of the sheet to one of a first type and a second type having larger sheet thickness than the first type; and
a sheet-type determining unit configured to determine whether the type of the sheet set by the sheet-type setting unit is the first type or the second type, wherein
the driving-mechanism control unit sets the angle larger if the sheet-type determining unit determines that the type of the sheet is the second type than if the sheet-type determining unit determines that the type of the sheet is the first type.

13. The apparatus of claim 11, further comprising:
a jam sensor configured to detect the sheet that passes the fixing member;
a jam determining unit configured to determine, on the basis of a detection signal from the jam sensor, whether a sheet jam occurs;
a number-of-times-of-jam counting unit configured to count, as a number of times of jam, a number of times the jam determining unit determines that the sheet jam occurs; and
a number-of-times-of-jam determining unit configured to determine whether the number of times of jam is equal to or larger than the threshold, wherein
the driving-mechanism control unit sets the angle larger if the number-of-times-of-jam determining unit determines that the number of times of jam is equal to or larger than the threshold than if the number-of-times-of-jam determining unit determines that the number of times of jam is smaller than the threshold.

14. The apparatus according to claim 11, further comprising:
a number-of-pixels counting unit configured to count a number of pixels of an image that should be formed on the sheet; and
a number-of-pixels determining unit configured to determine whether the number of pixels is equal to or larger than a threshold, wherein
the driving-mechanism control unit sets the angle larger if the number-of-pixels determining unit determines that the number of pixels is equal to or larger than the threshold than if the number-of-pixels determining unit determines that the number of pixels is smaller than the threshold.

15. An image forming apparatus comprising:
a fixing member configured to come into press contact with a sheet while rotating and heat the sheet;
a peeling member configured to peel the sheet off the fixing member;
a driving mechanism configured to translate the peeling member to change the position of the peeling member with respect to a fixing position for the sheet on the fixing member; and
a driving-mechanism control unit configured to control the driving mechanism and set the position of the peeling member with respect to the fixing position.

16. The apparatus according to claim 15, further comprising:
an operation input unit configured to receive an operation input by a user;
a sheet-type setting unit configured to set, according to the operation input to the operation input unit, a type of the sheet to one of a first type and a second type having larger sheet thickness than the first type; and
a sheet-type determining unit configured to determine whether the type of the sheet set by the sheet-type setting unit is the first type or the second type, wherein
the driving-mechanism control unit sets a position of the peeling member with respect to the fixing position in a position closer to the fixing position if the sheet-type determining unit determines that the type of the sheet is the second type than if the sheet-type determining unit determines that the type of the sheet is the first type.

17. The apparatus of claim 15, further comprising:
a jam sensor configured to detect the sheet that passes the fixing member;
a jam determining unit configured to determine, on the basis of a detection signal from the jam sensor, whether a sheet jam occurs;
a number-of-times-of-jam counting unit configured to count, as a number of times of jam, a number of times the jam determining unit determines that the sheet jam occurs; and
a number-of-times-of-jam determining unit configured to determine whether the number of times of jam is equal to or larger than the threshold, wherein
the driving-mechanism control unit sets a position of the peeling member with respect to the fixing position in a position closer to the fixing position if the number-of-times-of-jam determining unit determines that the number of times of jam is equal to or larger than the threshold than if the number-of-times-of-jam determining unit determines that the number of times of jam is smaller than the threshold.

18. The apparatus according to claim 15, further comprising:
a number-of-pixels counting unit configured to count a number of pixels of an image that should be formed on the sheet; and
a number-of-pixels determining unit configured to determine whether the number of pixels is equal to or larger than a threshold, wherein
the driving-mechanism control unit sets a position of the peeling member with respect to the fixing position in a position closer to the fixing position if the number-of-pixels determining unit determines that the number of pixels is equal to or larger than the threshold than if the number-of-pixels determining unit determines that the number of pixels is smaller than the threshold.

19. A method of adjusting a gap between a fixing member and a peeling member in an image forming apparatus including the fixing member configured to come into press contact with a sheet while rotating and heat the sheet and the peeling member configured to peel the sheet off the fixing member, the method comprising moving, with a driving mechanism, the peeling member to change a size of a gap between a leading end of the peeling member and the fixing member.

20. The method according to claim 19, wherein
the image forming apparatus further includes an operation input unit configured to receive an operation input by a user,
the method further comprises:
setting, with the operation input unit, a type of the sheet to a first type or a second type having larger sheet thickness than the first type;
determining whether the set type of the sheet is the first type or the second type; and
setting the gap larger if it is determined that the type of the sheet is the second type than if it is determined that the type of the sheet is the first type.
